(19) United States
(12) Patent Application Publication
(10) Pub. No.: US 2011/0202551 A1
(43) Pub. Date: Aug. 18, 2011

(54) Apparatuses, Methods And Systems For Assurance Of Reputation

(75) Inventor: Bal Agrawal, Chappaqua, NY (US)

(73) Assignee: Lifeworx, Inc.

(21) Appl. No.: 12/706,341

(22) Filed: Feb. 16, 2010

(51) Int. Cl. G06F 17/30

(52) U.S. Cl. 707/769; 707/E17.014; 707/781; 707/E17.005

(57) ABSTRACT

The present invention discloses apparatuses, systems and methods for assurance of reputation and abilities. The disclosed apparatuses, methods, and systems provide mechanisms such that assurance of the reputation of a service provider can be provided to a client. This is accomplished by receiving an assurance request for a service provider, submitting queries to and receiving query responses from relevant data sources, analyzing the query responses to verify the service provider's reputation, and generating an assurance of the service provider's reputation if the analysis of the responses demonstrate that the service provider meets a predetermined level of reputation.

### FIELD

The present disclosed invention is generally directed to apparatuses, systems and methods for the communication of reputation. In particular, the disclosed invention pertains to the assurance of reputation and abilities to third parties through contractual relationships.

### BACKGROUND

Reputation is a fundamental element of human social interaction. Businesses and individuals strive to establish and maintain a good reputation. In particular, reputation serves as an efficient mechanism to establish trust between parties that do not have a past history of interaction upon which they can rely. For large organizations, trademarks and consumer reports are used to establish and represent their reputation. For example, when a customer is considering the purchase of a new car they will likely have a fairly accurate expectation of the level of quality and service they can expect from Ford, Toyota or BMW, even if the customer has never bought a car from any of these companies.

For small organizations and individuals, word of mouth recommendations and references from previous clients are often helpful, but these can be limited in their scope. One problem with client recommendations is that they carry limited history for new organizations that are without an established client base. Another concern is the burden that providing recommendations places on the business' customers. For example, some organizations might feel that requesting recommendations is an unacceptable imposition on their customers. For professional work in an office or institutional environment, the certifications and college degrees as well as interviews provide reasonable measure of a workers skill and personality and reputation may not be very critical. For example a nurse working in a Hospital can demonstrate her skills through certifications and previous experience. Her reputation may not be very critical in the performance of her job. However, within a small company or working in someone's home when the duties are to care for family, drive family members, handle cash and other assets, a full assessment of a person's reputation become critical.

### SUMMARY

This disclosure details the implementation of apparatuses, methods, and systems for assurance of reputation. Prior techniques for communicating reputation to a clients are limited, particularly for small organizations, individuals, and/or service providers that are new to a market or which provide low-volume services. The disclosed apparatuses, methods, and systems provide mechanisms such that assurance of the reputation of a service provider can be provided to a client.

Accordingly systems and methods are disclosed for providing an assurance of a service provider's reputation involving: receiving an assurance request for a service provider, the request including one or more pieces of service provider identifying information; submitting one or more queries to one or more data sources containing information relevant to the service provider's reputation, each query including at least one of the one or more pieces of service provider identifying information; receiving one or more query responses from the one or more data sources, wherein the responses comprise information relevant to the service provider's reputation; analyzing the query responses to verify the service provider's reputation; and generating an assurance of the service provider's reputation if the analysis of the responses demonstrate that the service provider meets a predetermined level of reputation, wherein the assurance includes a guarantee that the service provider meets the predetermined level of reputation.

The disclosed systems and methods can further advantageously include tailoring the assurance to a category of service to be performed and using a rule set for the category of service to be performed to specify the one or more pieces of service provider identifying information required and the one or more data sources to which the one or more queries should be submitted. Each rule set for a given service type would define the types of data to be received from the service provider and the process to be performed to conduct the assurance analysis.

The disclosed systems and methods can further advantageously include analyzing query responses to determine an assurance grouping category for a service provider, wherein an assurance grouping category indicates a predetermined level of reputation. The systems and methods further including that a predetermined level of reputation is achieved if there was no criminal history within the previous 5 years, a clean driving record, and passing a drug test. The systems and methods further including that a predetermined level of reputation is achieved if there is a credit score above 700, a verified employment history of at least 2 years, and a bonding by a professional organization. The systems and methods further including that a predetermined level of reputation is achieved if a successful polygraph examination, a verified Social Security number, and a verified professional education.

The systems and methods further including wherein the assurance is triggered to require payment if it is inaccurate. The systems and methods further including wherein the assurance is triggered to require payment if there is a negative outcome and the assurance is inaccurate. The systems and methods further including wherein the assurance is triggered to require payment if there is a negative outcome and an aspect of the assurance related to the negative outcome is inaccurate.

Most of the assignments that service providers are hired for have a specific duty and the background information about that specific duty is relevant, while other factors are not as critical. For example a nurse working in a hospital may have to show and prove her nursing abilities, certification and experiences. However, since she is not working in someone's home and she is not driving a client to appointments, the credit check and drives license check may not be relevant for her specific job in the Hospital. However if she is working in someone's home, where she may drive the patient, or be exposed to household assets of a patient, insight into her reputation and good assessment of her reputation become critical. Not only the knowledge of reputation is critical, the assurance of such reputation provided the needed security to the individual seeking the services from the Nurse.

### BRIEF DESCRIPTION OF THE DRAWINGS

The accompanying appendices and/or drawings illustrate various non-limiting, representative, inventive aspects in accordance with the present disclosure:

FIG. 1 illustrates an overview of one embodiment of the disclosed system.

FIG. 2 illustrates an example table from one embodiment of the disclosed system.

FIG. 3 illustrates an overview of another embodiment of the disclosed system.

FIG. 4 illustrates an embodiment of a client interface in accordance with the disclosed system.

FIG. 5 illustrates an overview of a further embodiment of the disclosed system.

FIG. 6 illustrates an embodiment of an interface in accordance with the disclosed system.

FIG. 7 illustrates a systemization diagram for an embodiment of the disclosed system.

### DETAILED DESCRIPTION

In the following description, reference is made to the accompanying drawings, which show by way of illustration various exemplary embodiments that practice the disclosed invention. It is to be understood that other embodiments may be utilized and structural and functional modifications may be made without departing from the scope of the present invention.

A representative problem that can be solved by employing the teachings of the disclosed invention is assurance of a service provider's reputation. The teachings of the disclosed invention may be particularly useful for services, such as housekeeping, that are typically performed by small companies or individuals. Characteristically, a service provider may offer references, work history, and/or documentation of training completed in order to prove their reputation to a client. While each of these methods may give the client some indication of the service provider's reputation and ability, the client will have limited information as to the truthfulness of the service providers' information and no recourse if the service providers misrepresent themselves. This problem is particularly significant if a service provider is working in a client's home where a strong reputation, and the attendant confidence that the person is sufficiently trustworthy to allow in one's home, is often especially important to the client. For service providers, providing convincing proof of reputation, and ability, to a client can be time consuming, expensive, and tedious. Likewise, for a client, who has neither the expertise nor the tools to accurately verify a service provider's information, researching whether a service provider is reputable can also be time consuming and costly. Then even if the client completes the review, there is no guarantee that they have found all the relevant information. Furthermore, for a service provider that has numerous clients, it is simply inefficient to have all of that provider's clients repeat the same verification process.

The effort required to sufficiently establish and verify the reputations of service providers is greatly reduced by providing apparatuses, methods and systems for the assurance of service providers' reputations. The apparatuses, methods and systems are particularly useful when they are standardized such that a service provider's reputation and background information can be systematically collected and verified using relevant data sources. As described in detail below, the assurance system operates to test, confirm and/or generate assurances as to the service provider's reputation, quality and/or character. In some embodiments, an additional guarantee of the system's assurances of reputation, quality and/or character may be provided.

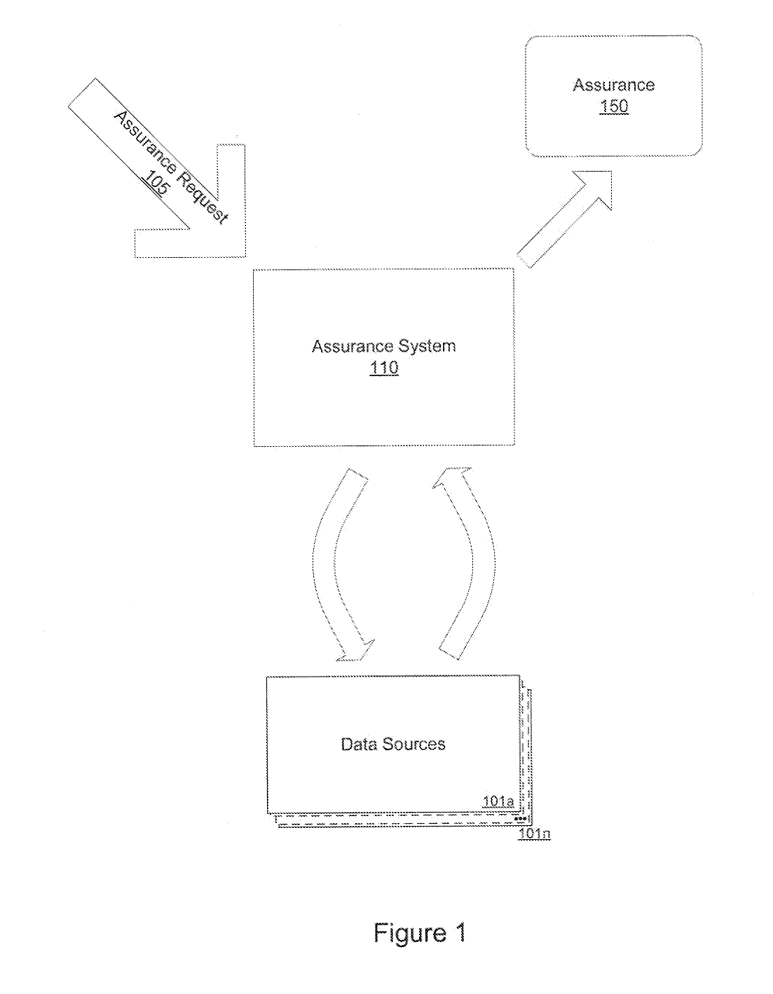

To that end, FIG. 1 shows an overview of the operation of an embodiment of the assurance system. The assurance system 110 receives an assurance request 105 that includes a service provider's identifying information, and in a further embodiment, the particular category of the service provided. The collected information might include for example, name, address, and social security number, for the purposes of identification. In an embodiment where the service provider's service category is provided additional information relevant to the service would also be collected. For example, if a particular service required licensing, proof of license could be collected. Other more general information could also be collected such as length of time in the field, prior work experience, and references. The particular data collected would of course be dependent on the service provided and would be readily obtainable by a person of skill in the art.

In one embodiment, the assurance system may verify the information submitted in the assurance request prior to using the information for the assurance analysis. In addition, the assurance system may notify the service provider that the assurance request has been received.

The assurance system 110 then queries data sources 101a-101n for information regarding the service provider in question. The following is a non-limiting sample of possible data sources 101a-101n: the assurance system's internal databases and specifications; Social Security Administration databases; state motor vehicle department records; local, state, and federal criminal databases; the Better Business Bureau; credit reporting agencies; educational institutions; professional and trade organizations; and former employers and customers. Further existing sources would readily ascertainable and additional future sources may later be deployed without departing from the teachings disclosed herein.

In a further embodiment, a rule set corresponding to the category of service provided may be used to streamline the reputation and background information collection. For example, the rule set for a plumber could indicate that the assurance system query the Plumber and Steamfitter's Union and appropriate trade schools while the rule set for a childcare service provider would not require querying these particular data sources. In a further embodiment, queries are submitted to data sources according to a hierarchical ordering such that if, for example, the Social Security number for a service provider was invalid, the assurance system would not continue to query other data sources.

Using the structure shown in FIG. 1, the assurance system 110 could communicate with the data sources 101a-101n in a variety of ways, depending on the access requirements and restrictions of the data sources. In one approach, the assurance system could generate queries and receive responses over electronic networks using whatever protocols are required by the particular data source. This could be advantageously accomplished by developing a modular interface architecture, with a specific interface for each data source. If that approach is not feasible for certain indicated data sources, the system could also generate telephone, facsimile, hardcopy and/or similar requests for information and be able to receive and process the corresponding responses. These could be advantageously organized and queued for human operators to process. In another embodiment, the assurance system could also generate and transmit tests and test requests, and receive and evaluate completed tests and/or test results. The tests, for example, could be used to confirm knowledge of routine safety practices or a given level of knowledge about the given service area. In a further embodiment, the assurance system may request and receive medical exams and evaluations, physiological evaluations, medical histories, and insurance histories for service providers. As necessary, the assurance system may be further configured to comply with applicable privacy and data protection requirements. For example, certain data sources may require a waiver from the service provider in question before disclosing information to the assurance system. In such cases, the assurance system could generate the appropriate waiver and transmit it to the service provider. The service provider could complete the waiver and submit it to the assurance system and/or the data source. Responses may be processed as indicated above. In a further embodiment, the completion of a disclosure waiver is provided as part of the assurance request.

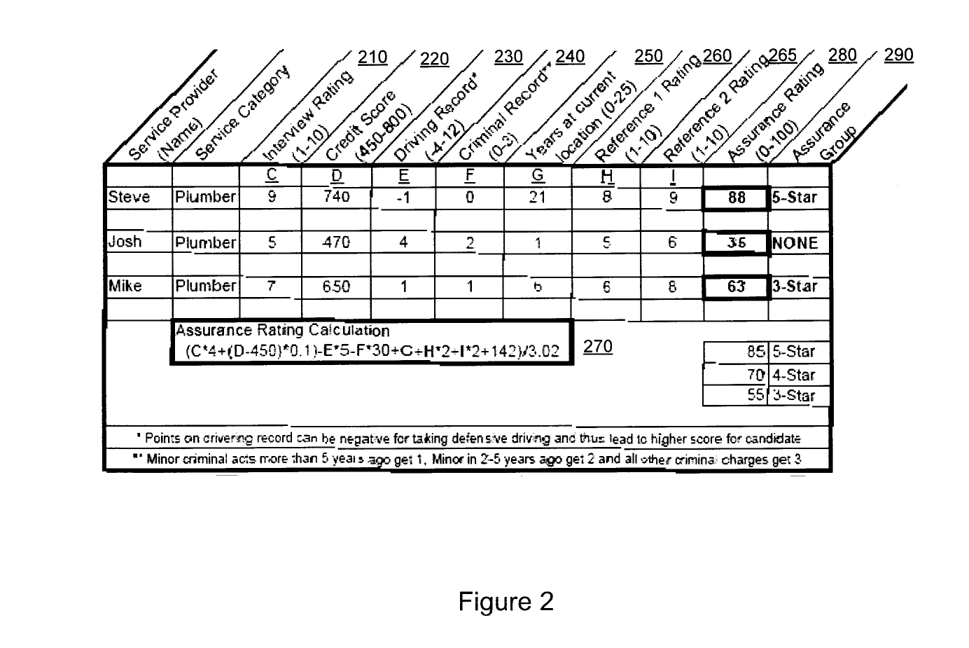

Upon receipt of the information requested, the assurance system analyzes the content and quality of the collected data with respect to the indicated service category and generates a corresponding assurance rating. FIG. 2 provides an example table illustrating how one embodiment of the disclosed system could determine assurance ratings for service providers. As shown for each of the service providers identified, service category and metrics corresponding to reputation data was collected (e.g., interview rating, credit history, driving record, criminal record, years at current location, and ratings based on reference checks). It has been determined that credit history is a particularly good measure of general overall responsibility, with a credit history of 700 or over being particularly indicative of high responsibility. Additional data may also be collected, including but not limited to results of a drug test, results of a polygraph, verification that the service provider is bonded, employment history and/or education history. The assurance system uses the collected data to determine an assurance rating for each service provider, as shown in the example, in which the assurance system uses the equation (C*4+(D−450)*0.1−E*5−F*30+G+H*2+I*2+142)/3.02 and the indicated reputation data metrics to determine each service provider's assurance rating. While this exemplary equation can be advantageously employed other variations for balancing the received data gathered could be used without departing from the spirit of the current disclosure.

It may also be particularly advantageous to conduct an in-person interview with the service provider and submit the results of that interview to the assurance system. This could be done by having the interviewer provide graded ratings of the service provider. This would provide a mechanism to record and compare the subject data derived from the interview.

The system may further use a service provider's assurance rating to determine whether to provide assurance for a service provider (i.e., no assurance will be provided if a service provider's assurance rating is below a certain threshold). The assurance rating may further be used to determine a service provider's assurance group (e.g., 3-Star, 4-Star, 5-Star). For Steve, the first plumber listed in FIG. 2, the assurance system collected positive data including a strong work history, no criminal convictions, and a good credit history. Accordingly, the assurance system generated a high assurance rating for Steve. However, if the assurance system collects negative or incomplete data for a service provider, as demonstrated by the other plumbers listed, the assurance system generates a relatively lower assurance rating for the service provider. The table shown is merely exemplary, and other methods for determining assurance ratings for service providers that could alternatively be employed would be readily ascertainable by those of skill in the art.

The calculated assurance rating of a service provider may prove informative and valuable to the client. However, the client would have little recourse if the rating were inaccurate or based on incomplete information, thus making it difficult for the client to place verifiable trust in the assurance rating.

As shown in FIG. 1, the assurance system 110 may address this problem with an assurance 150 of the service provider's reputation. The assurance is an affirmation of reputation, underwritten at a predetermined level of financial liability. In one embodiment, the assurance system may use a service provider's assurance rating to determine the service provider's assurance level, with the assurance level indicating the financial compensation provided to the client by the assurance. Thus, high quality and trustworthy information indicating a level of skill might be indicated through a higher assurance dollar value than an assurance value based on lesser information.

In a further embodiment, the assurance system may determine a maximum assurance value level using a service provider's assurance rating, where the maximum assurance level indicates the upper limit of the financial compensation available to be provided by the assurance. The assurance level of the assurance could be selected at or below the maximum assurance level determined by the assurance system, with different costs associate with the different levels. This might be particularly advantageous when, as described below, the assurance system operates as a third party that sells its assurance services to third party service providers or end customers.

The assurance system may further identify under what conditions the assurance is triggered (i.e., the assurance provides a payout), and in what amounts compensation is provided to the client. In one embodiment, the condition necessary to trigger the assurance could simply be the discovery that the service provider's assurance is negatively and factually incomplete or incorrect. For example, if a childcare provider has an assurance indicating that the provider has no criminal record, and a client who received the assurance discovered a prior shoplifting conviction, the client may be entitled to the compensation indicated by the assurance.

In another embodiment, the condition necessary to trigger the assurance may require an adverse event or outcome in addition to the discovery that the assurance of the service provider is factually incomplete or incorrect. For example, if a plumber causes water damage to a client's house, the assurance would be open for review, and any error in the assurance, such as with the plumber's driving record, would trigger the assurance. If, however, the assurance were accurate nothing would be paid. This would distinguish the assurance from typical insurance and underwriting.

Similarly, in a further embodiment, like the previous example, the assurance would require a negative event to be triggered, but would additionally require that the error in the assurance be related to the adverse event. Using the same facts as the example above, the error in the assurance regarding the plumber's driving record would not trigger the assurance. However, the assurance would be triggered if the assurance indicated the plumber had more experience than the plumber actually had (i.e., the water damage caused by the plumber is related to the plumber's lack of experience).

Under triggering conditions, including those listed previously, once the assurance is triggered, payout to the client could be for the entire value of the assurance (i.e., the assurance level), limited to the cost of the adverse event, or defined according to a compensation structure set by the assurance.

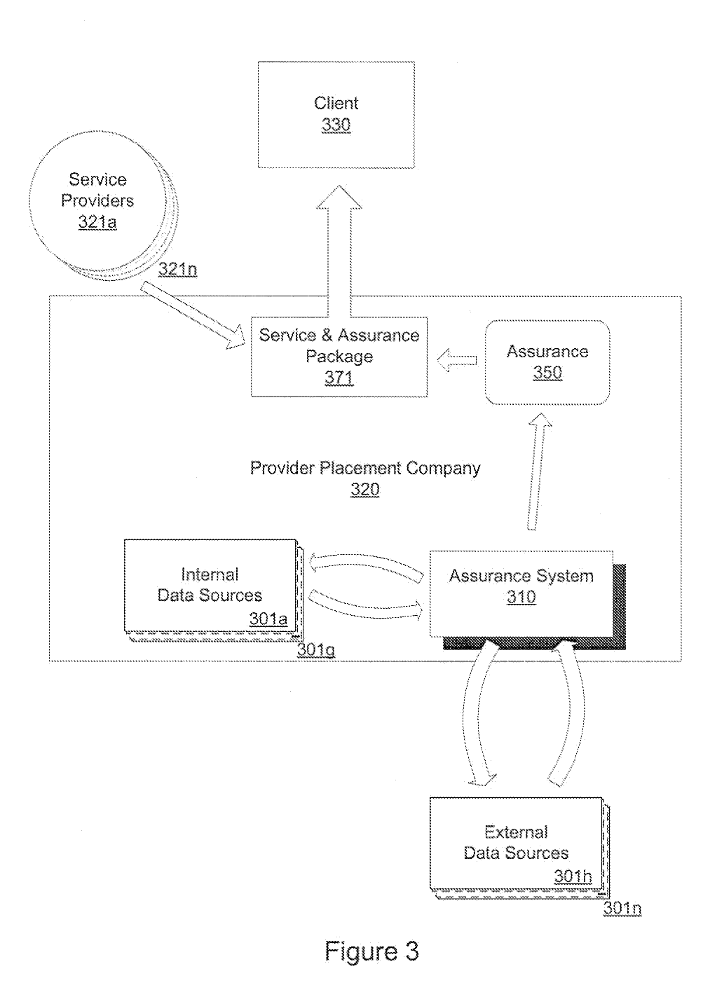

FIG. 3 provides a schematic overview of an embodiment in which a provider placement company 320 has an internal assurance system 310. A provider placement company enables clients to connect with service providers and arrange for work to be performed. The provider placement company may use the assurance system to generate assurance ratings for service providers 321a-321n employed, contracted, or represented by the provider placement company. Using the service provider's assurance rating, the assurance system could determine an assurance level and generate an assurance 350 of the service provider. The provider placement company may combine a service provider and the corresponding assurance into a service and assurance package 371 to be marketed to a client 330.

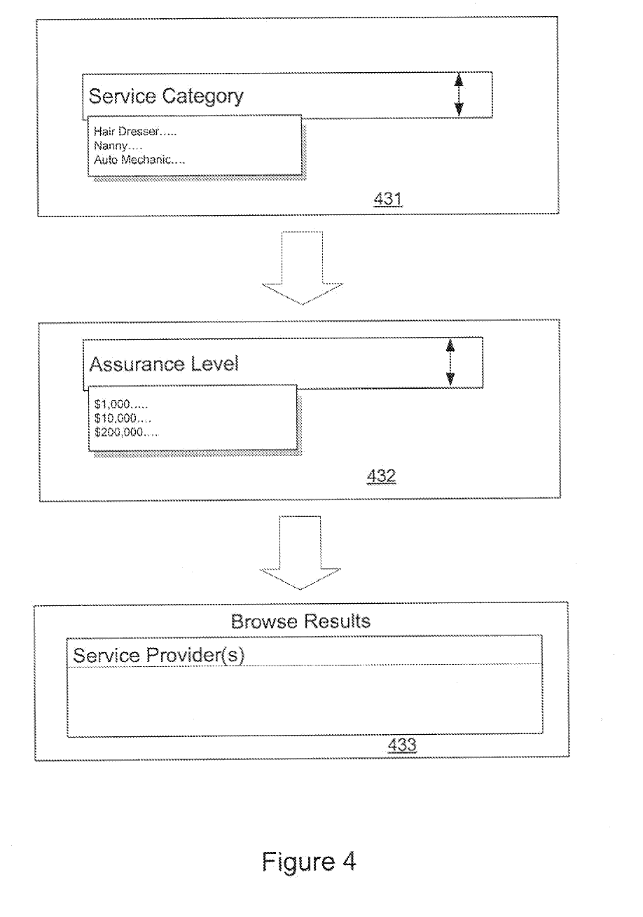

In a further embodiment, the assurance system could allow clients to use assurance ratings and/or assurance levels in searching and selecting a service provider. FIG. 4 gives an example of an interface that the assurance system may generate to allow a client to select and request a service provider. The assurance system could, for example, implement this interface on a web page or the interface could be provided in a software system accessed by employees of a provider placement company who in turn input the requests of the client. In one embodiment, the client selects a service category 431 and a desired assurance level 432, and receives a listing of service providers 433 meeting the specified criteria. In a particular embodiment, the assurance level and/or assurance of a service provider could be determined in advance of the client search such that the service provider(s) meeting the client's criteria could be identified immediately, from which the client may select the desired service provider. In another embodiment, the assurance system could review the client's criteria, identify a service provider who can be assured to the assurance level desired by the client, and then create an assurance meeting the client's specifications. The interface shown is merely exemplary, and other suitable interfaces that could alternatively be employed would be readily ascertainable by those of skill in the art.

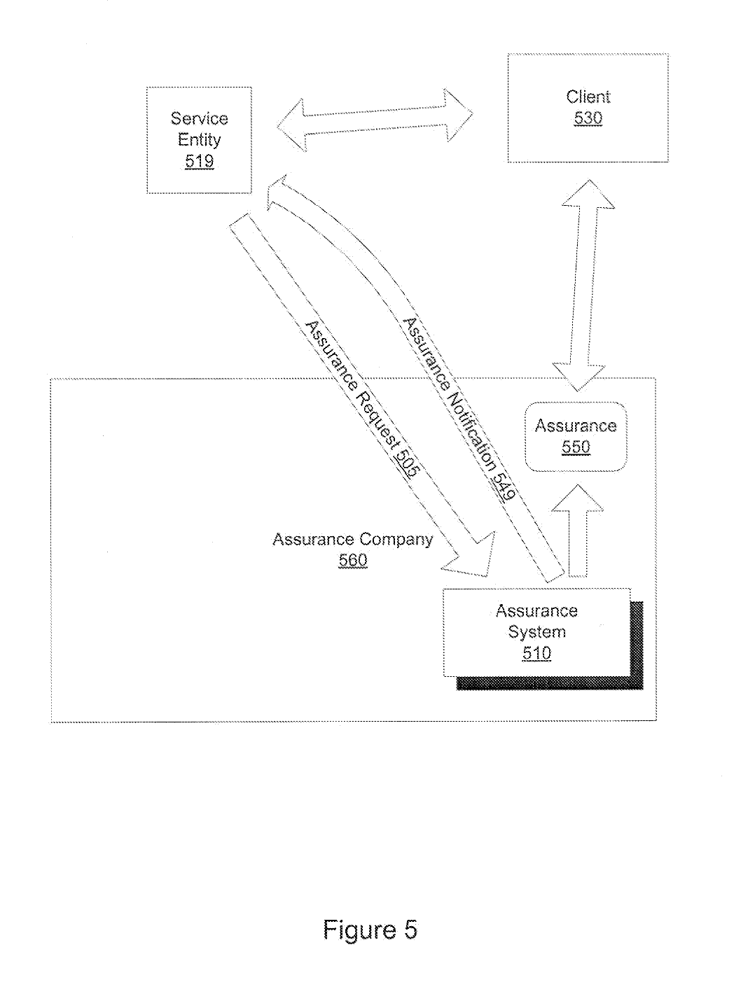

FIG. 5 provides a schematic overview of an embodiment in which a service entity 519 (which may include but is not limited to a service provider or a provider placement company) may submit an assurance request 505 to an assurance company's 560 assurance system 510. The assurance system processes the assurance request, determines the assurance rating and calculates the assurance level of the service entity. The assurance system may generate an assurance 550 and give the service entity 519 an assurance notification 549 indicating that the assurance has been generated. The service entity may use the existence of the assurance as verification of reputation, which may be particularly useful in marketing the service entity to potential clients (e.g., the service entity's reputation is assured to the client for $20,000). A client 530 of the service entity 519 may receive the assurance 550 of the service entity from the assurance company 560.

In another embodiment, the assurance system may generate a schedule for various assurance levels. For example, if an assurance company charged a fee for providing different levels of assurance, a certain service entity may not want to pay the fee for the maximum assurance level available. The service entity could select the desired assurance level and fee from the schedule. If the service entity has the appropriate assurance rating, the assurance system can then generate an assurance of the service entity for the indicated assurance level.

In a further embodiment, the assurance may require a periodic renewal that re-performs some or all of the assurance process to ensure the service provider still meets the standards of the assurance rating. Such a renewal may take into account reviews from clients who have retained the service provider after the issuance of the original assurance. The renewal could also be triggered or affected by negative events that resulting in payment pursuant to the assurance. Or, the renewal could be triggered by mere client requests for payment of an assurance. This renewal process could incur an additional fee or could be included in the original assurance cost.

An example application of how the system might operate for a specific service provider follows. A housekeeper has poor driving record, no criminal record, good references and very good credit history. She appears to be very competent in her work. The housekeeper is very capable of doing childcare too, and client has asked for her reputation and assurance ratings and an assurance level of $50,000 that all her background is fully evaluated and clean. When she is evaluated as a housekeeper, her driving record becomes less relevant and her assurance rating is high. The client is provided the assurance for the desired assurance level at the fee of $20/week. Her assurance level is re-evaluated every three months and confirmed with the client of the assurance rating. This housekeeper works for the client three days a week. Another client has asked for her services for two afternoons a week to carry out housekeeping and drive children to their activities. The assurance system is asked to provide a reputation level of this housekeeper as a childcare provider, including driving duties. The assurances system response based on the predetermined algorithm is that the housekeeper does not have a strong reputation for childcare including driving. Thus, no assurance is available. The system continues to track the driving record of the provider and three years later. It finds that the housekeeper had no traffic violations in that period and updates the reputation for the housekeeper as suitable for childcare and driving duties.

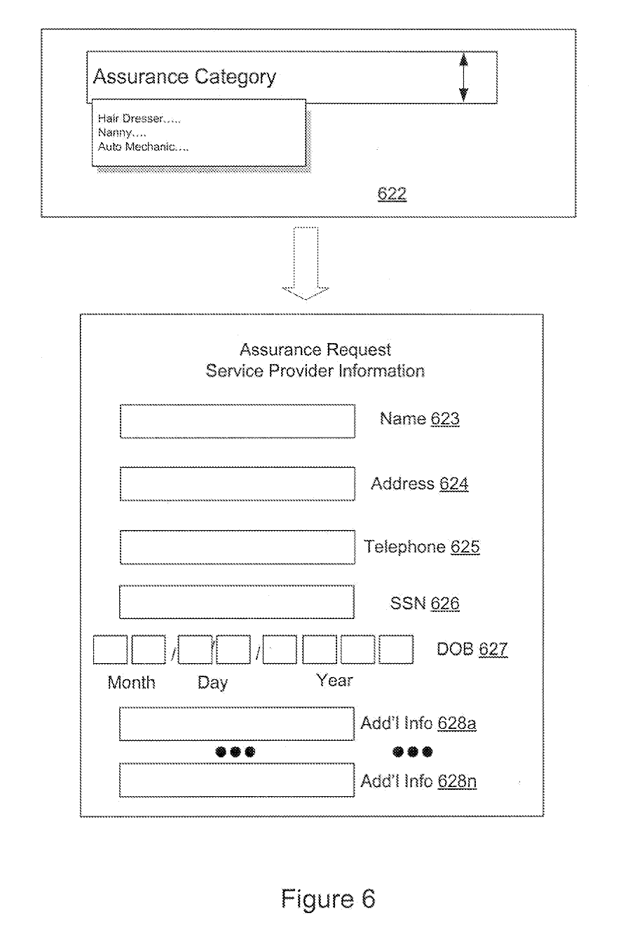

FIG. 6 provides an example of an interface provided by the assurance system to receive an assurance request. The assurance system could, for example, implement this interface on a web page. In one embodiment, the appropriate service category 622 may be selected and text may be entered in the corresponding fields for the service provider's name 623, address 624, telephone number 625, Social Security number 626, and date of birth 627.

Additional information may be entered under in fields 628a-628n, such as previous names used, state ID number(s), student ID number(s), business addresses, and/or educational background. The fields of the assurance request interface in FIG. 6 are merely exemplary. Other information could be gathered, as needed, and various fields in FIG. 6 may be excluded. The interface shown is merely exemplary, and other suitable interfaces readily created by people of skill in the art to alternatively be employed. In a further embodiment, biometric identification, such as fingerprints, iris scans, or DNA samples, may also be received by the assurance system.

In another embodiment, the assurance system could provide a predicted or estimated assurance rating and assurance level based on the stated reputation and ability of a service provider. For example, a service provider who is considering getting an assurance may not want to go through the entire process without an approximate idea of what the outcome (i.e., the service provider's assurance rating and assurance level) may be. This may be especially important if there is a fee charged to by the assurance system and/or by the data sources that may be queried by the assurance system. In this embodiment, the assurance system could analyze the stated reputation and ability of a service provider and generate an estimated assurance rating and estimated assurance level. That information could be used in deciding whether to submit an assurance request.

In one embodiment, the assurance may include a date of issue and specified time period over which it assures a service provider's background such as, for example, up to 3 years from the date of issue. In another embodiment, the assurance may include an expiration date or period, after which it is no longer valid. In a further embodiment, the assurance may be designed such that it is renewable, either by request or automatically. In a further embodiment, specified data sources that may change over time, such as, for example, a service provider's driving record, may be periodically queried in order to update a service provider's assurance.

In another embodiment, the assurance system may provide assurance limited to specified aspects of a service provider's reputation and abilities. For example, the system may provide an assurance that a service provider has no criminal history and a certain skill set, while not providing any assurance as to the service provider's credit score or driving record.

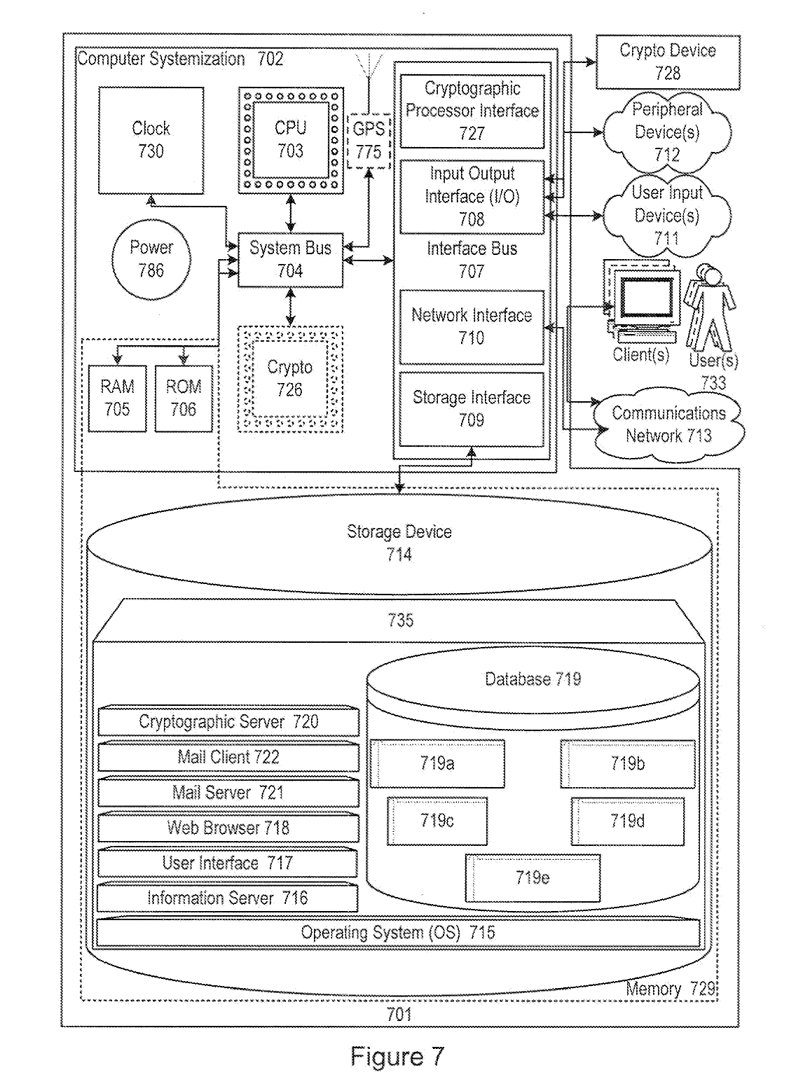

FIG. 7 of the present disclosure illustrates inventive aspects of an assurance system controller 701 in a block diagram. In this embodiment, the assurance system controller 701 may serve to accept, retrieve, store, search, serve, submit, identify, transmit, instruct, generate, match, and/or update databases containing relevant assurance information and/or service provider information and/or related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the assurance system controller 701 may be connected to and/or communicate with entities such as, but not limited to: one or more users from user input devices 711; peripheral devices 712; and/or a communications network 713.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The assurance system controller 701 may be based on common computer systems that may comprise, but are not limited to, components such as: a computer systemization 702 connected to memory 729.

Computer Systemization

A computer systemization 702 may comprise a clock 730, central processing unit (CPU) 703, a read only memory (ROM) 706, a random access memory (RAM) 705, and/or an interface bus 707, and most frequently, although not necessarily, are all interconnected and/or communicating through a system bus 704. Optionally, the computer systemization may be connected to an internal power source 786. Optionally, a cryptographic processor 726 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, Core and/or XScale; and/or the like processor(s). The CPU interacts with memory through signal passing through conductive conduits to execute stored program code according to conventional data processing techniques. Such signal passing facilitates communication within the assurance system controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 786 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the assurance system controller thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 710 may accept, communicate, and/or connect to a communications network 713. Through a communications network 713, the assurance system controller is accessible through remote clients 733b (e.g., computers with web browsers) by users 733a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to user input devices 711, peripheral devices 712, cryptographic processor devices 728, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 711 may be card readers, dongles, finger print readers, gloves, graphics tablets, joysticks, keyboards, mouse (mice), remote controls, retina readers, trackballs, trackpads, and/or the like.

Peripheral devices 712 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the assurance system controller may be embodied as an embedded, dedicated, and/or monitor-less (i.e., headless) device, wherein access would be provided over a network interface connection.

Memory

Generally, any mechanization and/or embodiment allowing a processor to affect the storage and/or retrieval of information is regarded as memory 729. However, memory is a fungible technology and resource, thus, any number of memory embodiments may be employed in lieu of or in concert with one another. It is to be understood that the assurance system controller and/or a computer systemization may employ various forms of memory 729. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 729 will include ROM 706, RAM 705, and a storage device 714. A storage device 714 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 729 may contain a collection of program and/or database modules and/or data such as, but not limited to: operating system module(s) 715 (operating system); information server module(s) 716 (information server); user interface module(s) 717 (user interface); Web browser module(s) 718 (Web browser); database(s) 719; cryptographic server module(s) 720 (cryptographic server); the assurance system module(s) 735; and/or the like (i.e., collectively a module collection). These modules may be stored and accessed from the storage devices and/or from storage devices accessible through an interface bus. Although non-conventional software modules such as those in the module collection, typically, are stored in a local storage device 714, they may also be loaded and/or stored in memory such as: peripheral devices, RAM, remote storage facilities through a communications network, ROM, various forms of memory, and/or the like.

Operating System

The operating system module 715 is executable program code facilitating the operation of the assurance system controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the assurance system controller to communicate with other entities through a communications network 713. Various communication protocols may be used by the assurance system controller as a subcarrier transport mechanism for interaction, such as, but not limited to: multicast, TCP/IP, UDP, unicast, and/or the like.

Information Server

An information server module 716 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the assurance system controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the assurance system controller, operating systems, other program modules, user interfaces, Web browsers, and/or the like.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 717 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 718 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the assurance system enabled nodes. The combined application may be nugatory on systems employing standard Web browsers.

Assurance System Controller Module

The assurance system controller module 735 is stored program code that is executed by the CPU. The assurance system controller module affects accessing, obtaining and the provision of assurance system, and/or the like across various communications networks.

The assurance system controller module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. The assurance system controller module may communicate to and/or with other modules in a module collection, including itself, and/or facilities of the like. Most frequently, the assurance system controller module communicates with the assurance system database!, operating systems, other program modules, and/or the like. The assurance system controller module may contain, communicate, generate, obtain, and/or provide program module, system, user, and/or data communications, requests, and/or responses.

Distributed Assurance System Controller Module

The structure and/or operation of any of the assurance system controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the assurance system controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A method for providing an assurance of a service provider's reputation comprising:
receiving an assurance request for a service provider, the request including one or more pieces of service provider identifying information;
submitting one or more queries to one or more data sources containing information relevant to the service provider's reputation, each query including at least one of the one or more pieces of service provider identifying information;
receiving one or more query responses from the one or more data sources, wherein the responses comprise information relevant to the service provider's reputation;
analyzing the query responses to verify the service provider's reputation; and
generating an assurance of the service provider's reputation if the analysis of the responses demonstrate that the service provider meets a predetermined level of reputation, wherein the assurance includes a guarantee that the service provider meets the predetermined level of reputation.

2. The method of claim 1 further comprising the assurance request including a category of service to be performed.

3. The method of claim 1 further comprising verifying the information submitted in the assurance request.

4. The method of claim 1 further comprising notification of the service provider that the assurance request has been received.

5. The method of claim 1 wherein at least one of the one or more queries is submitted to an internal data source.

6. The method of claim 1 further including receiving the results of an in-person interview.

7. The method of claim 1 wherein at least one of the one or more queries is submitted to an external data source.

8. The method of claim 2 further comprising using a rule set for the category of service to be performed to specify the one or more pieces of service provider identifying information required and the one or more data sources to which the one or more queries should be submitted.

9. The method of claim 7 further comprising a hierarchical ordering for submitting the queries to the data sources.

10. The method of claim 7 further comprising requesting that the service provider grant permission for at least one of the data sources to respond to at least one of the queries.

11. The method of claim 1 further comprising notifying the service provider that the assurance has been generated.

12. The method of claim 1 further comprising presenting the assurance of the service provider's reputation to a client of the service provider.

13. The method of claim 1 wherein at least one of the one or more pieces of service provider identifying information includes a name.

14. The method of claim 1 wherein at least one of the one or more pieces of service provider identifying information includes a date of birth.

15. The method of claim 1 wherein at least one of the one or more pieces of service provider identifying information includes a Social Security number.

16. The method of claim 12 further comprising providing financial compensation to the client if the service provider is shown not to meet the guaranteed predetermined level of reputation.

17. The method of claim 16 wherein the query responses are analyzed to determine the financial compensation to be provided to the client if the service provider is shown not to meet the guaranteed predetermined level of reputation.

18. The method of claim 1 further comprising analyzing query responses to determine an assurance grouping category for a service provider, wherein an assurance grouping category indicates a predetermined level of reputation.

19. The method of claim 1 wherein the predetermined level of reputation includes no criminal history within the previous 5 years, a clean driving record, and passing a drug test.

20. The method of claim 1 wherein the predetermined level of reputation includes a credit score above 600, a verified employment history of at least 2 years, and a bonding by a professional organization.

21. The method of claim 1 wherein the predetermined level of reputation includes a successful polygraph examination, a verified Social Security number, and a verified professional education.

22. The method of claim 1 wherein the assurance is triggered to require payment if it is inaccurate.

23. The method of claim 1 wherein the assurance is triggered to require payment if there is a negative outcome and the assurance is inaccurate.

24. The method of claim 1 wherein the assurance is triggered to require payment if there is a negative outcome and an aspect of the assurance related to the negative outcome is inaccurate.

25. The method of claim 1 further comprising receiving a fee for the assurance.

26. The method of claim 1 further comprising periodically renewing the assurance.

27. The method of claim 26 further comprising receiving a fee for the renewed assurance.

28. The method of claim 26 wherein the periodic renewal comprises resubmitting one or more queries to the one or more data sources containing information relevant to the service provider's reputation, each query including at least one of the one or more pieces of service provider identifying information; and, re-receiving one or more query responses from the one or more data sources, wherein the responses comprise information relevant to the service provider's reputation.

29. A method for providing an assurance of a service provider's reputation comprising:
receiving an assurance request relating to a service provider, the request including one or more pieces of service provider identifying information and service type identification;
determining a rule set to apply based on the received service type identification;
requesting and receiving additional information based on the rule set;
submitting one or more queries to one or more data sources defined by the rule set, each query including at least one of the one or more pieces of service provider identifying information;
receiving one or more query responses from the one or more data sources, wherein the responses comprise information relevant to the service provider's reputation;
analyzing the query responses to generate an assurance of the service provider's reputation if the analysis of the responses demonstrate that the service provider meets a predetermined level of reputation, wherein the assurance includes a guarantee that the service provider meets the predetermined level of reputation and defines circumstances under which the assurance will be deemed triggered.

30. A computer readable data carrier storing computer code for providing an assurance of a service provider's reputation wherein the computer code comprises instructions for performing the following steps:
receiving an assurance request for a service provider, the request including one or more pieces of service provider identifying information;
submitting one or more queries to one or more data sources containing information relevant to the service provider's reputation, each query including at least one of the one or more pieces of service provider identifying information;
receiving one or more query responses from the one or more data sources, wherein the responses comprise information relevant to the service provider's reputation;
analyzing the query responses to verify the service provider's reputation; and
generating an assurance of the service provider's reputation if the analysis of the responses demonstrate that the service provider meets a predetermined level of reputation, wherein the assurance includes a guarantee that the service provider meets the predetermined level of reputation.

31. An assurance system for providing assurance of a service provider's reputation, the assurance system comprises:
a memory;
a processor;
an input interface;
an output interface;
wherein the processor is configured to:
receive an assurance request for a service provider, via the input interface, the request including one or more pieces of service provider identifying information and store the request in the memory;
generate one or more queries using the request;
submit one or more queries to one or more data sources, via the output interface, containing information relevant to the service provider's reputation, each query including at least one of the one or more pieces of service provider identifying information;
receive one or more query responses from the one or more data sources, via the input interface, wherein the responses comprise information relevant to the service provider's reputation;
analyze the query responses, via the processor, to verify the service provider's reputation;
generate an assurance of the service provider's reputation if the analysis of the responses demonstrate that the service provider meets a predetermined level of reputation, wherein the assurance includes a guarantee that the service provider meets the predetermined level of reputation; and
output the assurance via the output interface.
